(19) United States
(12) Patent Application Publication
(10) Pub. No.: US 2023/0153828 A1
(43) Pub. Date: May 18, 2023

(54) CONSUMER-PROTECTING DEBT COLLECTION COMMUNICATION SERVICE

(71) Applicant: Seong Yang, Flushing, NY (US)

(72) Inventor: Seong Yang, Flushing, NY (US)

(21) Appl. No.: 17/961,199

(22) Filed: Oct. 6, 2022

Related U.S. Application Data
(60) Provisional application No. 63/278,584, filed on Nov. 12, 2021.

(51) Int. Cl. G06Q 30/00

(52) U.S. Cl. CPC G06Q 30/018

(57) ABSTRACT

Methods and associated services for consumer-oriented protections concerning communications between consumers and debt collectors are provided. In some embodiments, the service maintains debt collector profiles, which characterize known and suspected debt collectors. The debt collector profiles can include email addresses, telephone numbers, and other communication identifiers used by the debt collectors. When the service detects an incoming communication received at a user device associated with a consumer, it determines based on the debt collector profiles whether the communication is from a debt collector. If the communication is from a debt collector, the service can monitor the communication for compliance with one or more regulatory rules and/or communication preferences (of the consumer, the consumers employer, etc.). If the service detects a violation of the rules and/or preferences, the service can notify the consumer of the violation and perform additional actions.

### CROSS-REFERENCE TO RELATED APPLICATION(S)

This application is a non-provisional of and claims priority to U.S. Provisional Application No. 63/278,584 filed on Nov. 12, 2021 entitled “CONSUMER-PROTECTING DEBT COLLECTION COMMUNICATION SERVICE,” which is hereby incorporated by reference in its entirety for all purposes.

### BACKGROUND

Various laws exist that regulate the manner in which debt collectors communicate with consumers when attempting to collect debts. For example, the federal Fair Debt Collection Practice Act (FDCPA) establishes legal protection from abusive debt collection practices. In particular, the FDCPA and related state-level laws (collectively, “debt collection laws”) require certain conduct by debt collectors, while prohibiting other types of conduct.

Examples of debt collector conduct that is required by the FDCPA include identifying themselves to consumers, and notifying consumers of their right to dispute the debt.

Examples of debt collector conduct that is prohibited by the FDCPA include contacting consumers by telephone outside of certain hours (e.g., 8:00am to 9:00pm local time), contacting consumers during times known to be inconvenient to a consumer, and contacting the consumer at their place of employment if such contact is prohibited.

Although debt collection laws such as the FDCPA provide consumers with certain protections, it can be challenging for consumers to know of all those protections and of the remedies available to them in the case of violations by debt collectors. It would therefore be desirable to improve the manner in which debt collectors and consumers communicate, thereby providing consumers with the protections afforded to them by the FDCPA and other debt collection laws.

### BRIEF DESCRIPTION OF THE DRAWINGS

FIG. 1 is a network diagram illustrating an exemplary computing environment in which a consumer-protecting debt collection communication service operates.

FIG. 2 is a flow diagram illustrating an exemplary process for monitoring communication between a debt collector and consumer for violations.

FIG. 3 is a flow diagram illustrating an exemplary process for updating preferences concerning debt collector communications.

FIG. 4 is a flow diagram illustrating an exemplary process for updating a debt collector profile associated with a known or suspected debt collector.

The techniques introduced in this disclosure can be better understood by referring to the following Detailed Description in conjunction with the accompanying drawings.

### DETAILED DESCRIPTION

A service that enforces consumer-oriented protections concerning communications between consumers and debt collectors (the “consumer-protecting debt collection communication service”), and associated methods, is disclosed herein.

The service maintains a debt collector data set, which characterizes known and suspected debt collectors. For each debt collector characterized by the debt collector data set, the service maintains profile information that can identify the debt collector. Identifying information for a debt collector that can be maintained by the service can include the company name of the debt collector, phone numbers associated with the debt collector, mailing addresses associated with the debt collector, email addresses associated with the debt collector, social media profiles associated with the debt collector, and other identifying information. The debt collector data set can additionally include confidence scores for debt collectors, which characterizes the likelihood that the associated debt collector information (e.g., identifying information) is associated with a debt collector. As described herein, the debt collector data set is generated in part based on information received from consumers and other users of the service.

The service additionally maintains a regulatory rule data set, which characterizes rules, laws, regulations and other requirements and/or limitations imposed by various debt collection laws. For example, the regulatory rule data set can characterize different types of required and/or prohibited conduct as defined by debt collection laws. For each rule (associated with a type of conduct related to consumer communication or other regulated action), the regulatory rule data set can include a rule condition (e.g., what is the required or prohibited conduct), a rule geography (e.g., what is the geographic scope of the applicability of the rule, such as federal, a state, and/or a city), and a rule action (e.g., what remedies are available to a consumer if the rule is violated and/or what steps can be taken by the service if the rule is violated).

Using the debt collector data set and the regulatory rule data set, the service monitors communications from debt collectors to consumers (e.g., telephone calls, email messages, and/or social media messages), and detects whether any applicable rules have been violated. As described herein, the service can monitor incoming communications (e.g., telephone calls, email messages, social media messages) received by a consumer (e.g., on the consumer’s mobile device) and determine whether the communication is from a debt collector. For example, the service can determine the origin of the incoming communication (e.g., the caller’s phone number, the sender’s email address, or some other origin identifier), and determine whether the origin is associated with a debt collector (e.g., the origin is associated with a debt collector in the debt collector data set). In some embodiments, a mobile application installed on a consumer’s mobile device and in which aspects of the service are practiced, monitors incoming communications on the mobile device to detect instances of debt collector communications. In some embodiments one or more server computers, on which aspects of the service are practiced, receive data (e.g., communication data) from a mobile device or other computing system associated with a consumer and detect whether the communication data is indicative of a debt collector communication.

If the service (e.g., a mobile application installed on a consumer’s mobile device and/or one or more server computers) determines that an incoming communication received by a consumer is from a debt collector, the service performs certain notification actions and/or monitoring actions. For example, the service can notify the consumer (e.g., via a pop-up or other indicator on the consumer’s mobile device, an email sent to the consumer, etc.) that the incoming communication is from a debt collector. As a further example, based on the regulatory rule data set, the service can evaluate whether the debt collector communication adheres to applicable rules and regulations. For example, the service can evaluate whether the communication is received during prohibited hours, whether the communication includes a disclosure from the origin that they are a debt collector, etc. In some embodiments, the service monitors for adherence to only certain rules characterized by the regulatory rule data set, based on the location of the consumer (e.g., a state-level regulation may not be applied to a consumer who is located in another state). As described herein, the service can also monitor the debt collector communication for compliance with communication preferences associated with the consumer and/or the consumer’s employer. In some embodiments, the service performs voice recognition and/or text recognition on the incoming communication as an aspect of the evaluation.

If the service detects that the debt collector communication is in violation of one or more applicable rules, regulations, or preferences, then the service performs certain actions. For example, the service can notify the consumer (e.g., via a pop-up or other indicator on the consumer’s mobile device, an email sent to the consumer, etc.) of the violation. As a further example, the service can generate messages (e.g., email messages) to the debt collector and/or relevant enforcement agencies (e.g., the Federal Trade Commission and/or the Consumer Financial Protection Bureau) notifying the recipients of the violation. In some embodiments, the actions performed are based on the rule action, corresponding to the rule or regulation that was violated, which characterizes the appropriate actions to be taken.

As described herein, the service maintains communication preference data for consumers and/or employers of consumers. In some embodiments the service publishes the preferences, or otherwise makes the preferences available (e.g., via application programming interface), to users of the service. For example, the service can provide employers’ communication preferences so that users (e.g., debt collectors) can check those preferences before contacting a consumer. As a still further example, the service can provide a consumer’s communication preferences so that a debt collector can check those preferences before contacting the consumer.

Advantageously, by monitoring communications received by a consumer and detecting whether those communications are from a debt collector and/or in violation of various rules and regulations, the service is able to provide various benefits to consumers. For example, consumers may not be aware they are being contacted by a debt collector and of their rights when speaking with a debt collector. As a further example, consumers may not be aware of the remedies available to them if a debt collector violates the consumer’s rights. As a still further example, debt collectors may not be aware of consumers’ communication preferences, particularly if a debt has been sold to a different collector. The service addresses these challenges, among others, by detecting violations and notifying consumers of their available remedies. These and other advantages will be apparent to one of skill in the art based on the description of the service herein.

Various embodiments of the present technology will now be described. The following description provides specific details for a thorough understanding and an enabling description of these embodiments. One skilled in the art will understand, however, that the present technology may be practiced without many of these details or with alternative approaches. Additionally, some well-known structures or functions may not be shown or described in detail so as to avoid unnecessarily obscuring the relevant description of the various embodiments. The terminology used in the description presented below is intended to be interpreted in its broadest reasonable manner, even though it is being used in conjunction with a detailed description of certain specific embodiments of the present technology.

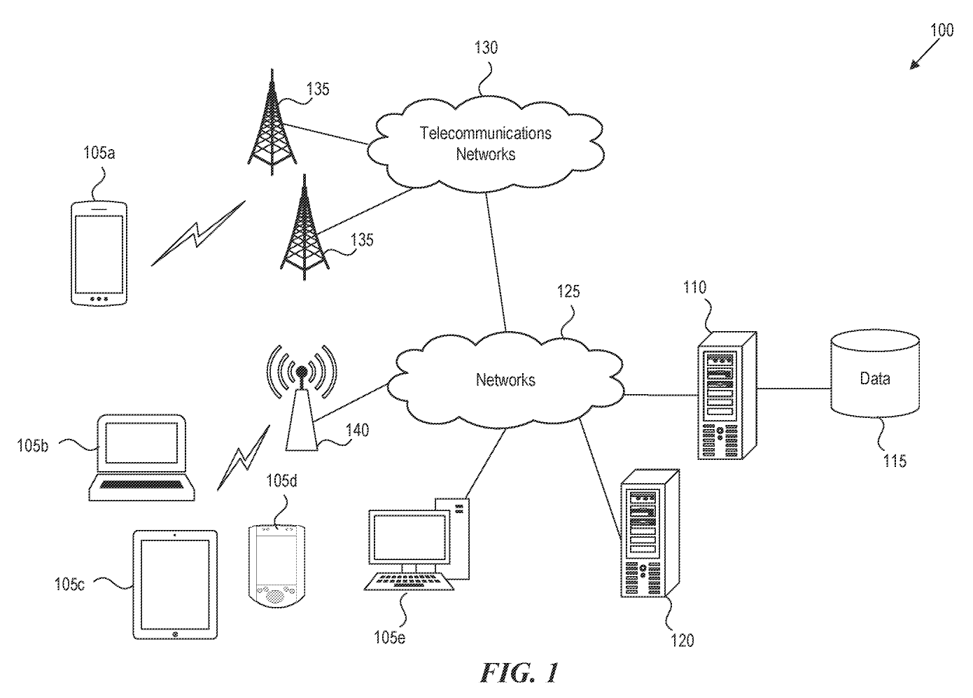

FIG. 1 is a network diagram illustrating an exemplary computing environment 100 in which a consumer-protecting debt collection communication service operates. Although not required, aspects of the service are described in the general context of computer-executable instructions, such as routines executed by a general-purpose computer, a personal computer, a server, or other computing system. The service can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random-access memory (RAM), read-only memory (ROM), flash memory, or the like, or a combination of such components. Computer-executable instructions may also be stored in one or more storage devices, such as magnetic or optical-based discs, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the service can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the service may be provided electronically over the Internet or over other networks (including wireless networks). Those skilled in the relevant art will recognize that portions of the service may reside on a server computer, while corresponding portions may reside on a client computer.

The environment 100 may include a plurality of user devices 105a-e that are respectively associated with a plurality of consumers (not shown). User devices 105a-e can include, without limitation, mobile devices, laptop computers, tablet computers, and personal computers. Consumers may receive various incoming communications at the respective associated user devices 105a-e, including telephone calls, email messages, social media messages, etc. The incoming communications may be from any of a number of third parties, including debt collectors (not shown). The debt collectors may communicate with the consumers in an attempt to collect any debts owed by the consumers (i.e., the consumers may be debtors).

The consumer-protecting debt collection communication service disclosed herein monitors communications received at the user devices 105a-e, determines whether the communications originate from debt collectors, and perform certain compliance monitoring and action steps accordingly. Aspects of the service may be implemented in and/or practiced by the user devices 105a-e and/or server computers 110. In some embodiments, for example, the user devices 105a-e (and/or an application associated with the service and running on the user devices 105a-e) are configured to detect when a communication is received, and transmit communication data characterizing the incoming communication to the server computers 110. The server computers 110 can be configured to evaluate the communication data and determine whether the corresponding communication originates from a debt collector. The server computers 110 can additionally be configured to evaluate the communication data (e.g., in real time during the communication and/or after the communication has ended) to detect occurrences of the communication from a debt collector violating applicable rules and regulations. The server computers 110 can transmit data to the user devices 105a-e indicating, for example, that a communication is from a debt collector, that the debt collector has violated an applicable rule or regulation, what actions are available to be taken in response to the violation, etc. In some embodiments, the user devices 105a-e (and/or the application running therein) are configured to perform the above-described steps (e.g., determine whether an incoming communication originates with a debt collector, detect debt collector communication violations, and/or perform actions). In some embodiments, the service performs voice recognition and/or text recognition on the incoming communication as an aspect of the evaluation.

The service may maintain data in the data storage area 115, utilized by the server computers 110. For example, the service may maintain a debt collector data set in data storage area 115, which characterizes known and suspected debt collectors. For each debt collector characterized by the debt collector data set, the service maintains profile information that can identify the debt collector. Identifying information for a debt collector in data storage area 115 can include the company name of the debt collector, phone numbers associated with the debt collector, mailing addresses associated with the debt collector, email addresses associated with the debt collector, social media profiles associated with the debt collector, and other identifying information. In some embodiments debt collector profiles can include multiple elements of identifying information for the same communication type (e.g., multiple phone numbers, multiple email addresses, etc.), which can facilitate detecting debt collectors that utilize multiple phone numbers to obscure their identity. The debt collector data set can additionally include confidence scores for debt collectors, which characterizes the likelihood that the associated debt collector information (e.g., identifying information) is associated with a debt collector. As described herein, the service may generate the debt collector data set based on information received from consumers and other users of the service.

The service may additionally maintain a regulatory rule data set in the data storage area 115, which characterizes rules, laws, regulations and other requirements and/or limitations imposed by various debt collection laws. For example, the regulatory rule data set can characterize different types of required and/or prohibited conduct as defined by debt collection laws. For each rule (associated with a type of conduct related to consumer communication or other regulated action), the regulatory rule data set can include a rule condition (e.g., what is the required or prohibited conduct), a rule geography (e.g., what is the geographic scope of the applicability of the rule, such as federal, a state, and/or a city), and a rule actions (e.g., what remedies are available to a consumer if the rule is violated and/or what steps can be taken by the service if the rule is violated). As described herein, the service may generate the regulatory rule data set based on information scraped from third-party sources, such as websites associated with debt collection laws.

To illustrate aspects of the consumer-protecting debt collection communication service, Table 1 illustrates representative regulatory rules, such as may be found in a regulatory rule data set maintained by the service.

TABLE 1

Representative Regulatory Rules

| | | |
|---|---|---|
| Rule Condition | Rule Geography | Rule Actions |
| Incoming communication before 8:00am | Federal | (1) Notify consumer (2) Prepare email notifying of violation of 15 U.S. Code § 1692c(a)(1) |
| Incoming communication after 9:00pm | Federal | (1) Notify consumer (2) Prepare email notifying of violation of 15 U.S. Code § 1692c(a)(1) |
| Threatening or abusive language | Federal | (1) Notify consumer (2) Prepare email notifying of violation of 15 U.S. Code § 1692d(1 ) |
| False representation of association with United States | Federal | (1) Notify consumer (2) Prepare email notifying of violation of 15 U.S. Code § 1692e(1 ) |
| Too frequent communication from debt collector (e.g., over a 7-day period) | Federal | (1) Notify consumer |
| False representation of association with New York | New York State | (1) Notify consumer (2) Prepare email notifying of violation of NY Gen Bus L § 601.1 |

Although the regulatory rules are represented above in a human readable table, it will be appreciated that the regulatory rule data set and the regulatory rules found therein may be found in other human readable and machine readable formats.

Returning to FIG. 1, the service may additionally maintain a consumer profile data set in the data storage area 115, which characterizes consumers. For each characterized consumer, the consumer profile data set can include a corresponding consumer profile that includes, for example, contact information associated with the consumer (e.g., personal telephone number, personal email address, work telephone number, work email address, social media handles, etc.), the consumer’s communication preferences, the identification of the consumer’s employer, and the consumer’s location. Communication preferences can include, for example, the days and times the consumer would prefer to be contacted by debt collectors, communication channels over which the consumer would prefer to be contacted by debt collectors (e.g., telephone, emails, messaging applications, social media), the preferred telephone number and/or email address for contacting the consumer, whether a debt collector can contact the consumer’s employer, etc. It will be appreciated that the communication preferences can also include prohibitions of the same (e.g., days and times the consumer does not want to be contacted). As described herein, the service can use the communication preferences to evaluate whether a debt collector is in violation of a consumer’s preferences. Furthermore, the service can use the identification of the consumer’s employer to identify the corresponding employer communication preferences. And the service can use the consumer’s location to identify which debt collection laws apply to the consumer. In some embodiments, consumers generate their corresponding consumer profile via, e.g., a website or mobile application associated with the service.

The service may additionally maintain an employer profile data set in the data storage area 115, which describes communication preferences of employers. For example, the employer profile data set can indicate whether an employer is willing to be contacted by debt collectors and/or whether an employer will allow debt collectors to contact the employer’s employees at their place of employment (e.g., contacting consumers through their work telephone number and/or work email address).

In some embodiments, the service generates the regulatory rule data set (maintained in data storage area 115) based on information scraped from third-party sources, such as websites or other computing systems associated with debt collection laws. For example, one or more third-party server computers 120 may host official records of debt collection laws. The server can periodically scrape information from the third-party server computers 120 to extract information characterization the debt collection laws (e.g., what the laws require, when the laws apply, and what are the remedies in case of violations of the law), based on which the service can generate the regulatory rule data set.

The service can additionally publish or otherwise provide (e.g., via an application programming interface, secure website, etc.) the consumer preferences and/or employer communication preferences (e.g., characterized by the consumer profile data set and the employer communication preference data set) to users of the service. For example, the service can provide the communication preferences to debt collectors so that the debt collectors are aware of consumers’ preferences.

The user devices 105a-e, the server computers 110, and the third-party server computers 120, communicate with each other through one or more public or private, wired or wireless networks 125 and 130, including, for example, the Internet and telecommunication networks. The user devices 105a-e can communicate wirelessly with a base station 135 or access point 140 using a wireless mobile telephone standard, such as the Global Service for Mobile Communications (GSM), Long Term Evolution (LTE), IEEE 802.11, or another wireless standard, and the base station 135 or access point 140 communicates with the server computers 110 and the third-party server computers 120 via the network 125. User devices 105a-e can also communicate through the network 125 using, for example, TCP/IP protocols. The user devices 105a-e can additionally communicate wirelessly with the telecommunication network 130 using, for example, nearby cell towers or base stations 135 using wireless mobile telephone standards, such as GSM, CDMA (Code Division Multiple Access), General Packet Radio Service (GPRS), and the like. The network 125 and telecommunication network 130 may be interconnected such that, for example, user devices 105a-e connected to the telecommunication network 130 can communicate via the network 125 with the server computers 110, third-party server computers 120, and other devices connected to the network. The user devices 105a-e utilize applications or other software, which operate through the use of computer-executable instructions. Some such applications may be directed toward monitoring incoming communications to identify those from a debt collector, and monitoring said communications for possible violations. As will be described in more detail herein, the consumer-protecting debt collection communication service residing at least in part on the server computers 110 may also utilize software which operates through the use of computer-executable instructions.

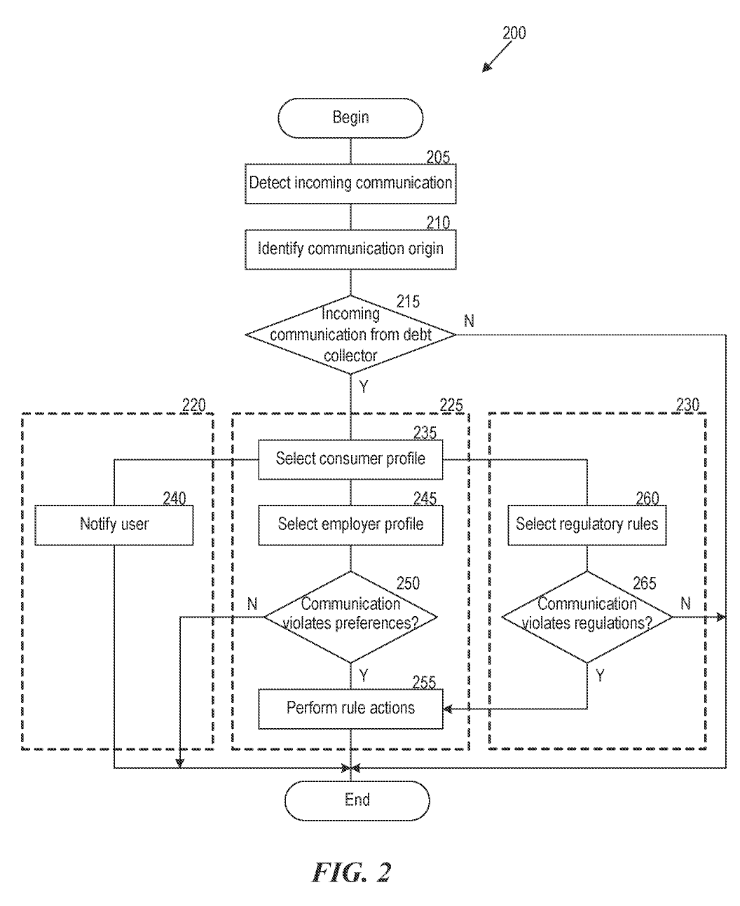

FIG. 2 is a flow diagram illustrating an exemplary process 200, executed by the consumer-protecting debt collection communication service, for monitoring communication between a debt collector and consumer for violations. The process 200 can be performed by any embodiment of the consumer-protecting debt collection communication service and associated devices described herein. For example, the process can be performed entirely by the user devices 105a-e of FIG. 1, entirely by the server computers 110 of FIG. 1, or by a combination of the user devices 105a-e and the server computers 110.

The process 200 begins at block 205, with the service detecting an incoming communication at a consumer’s user device. The incoming communication can be in the form of, for example, a telephone call, an email, a message received via a messaging application, a social media message, or other. The detection of the incoming communication can be facilitated, for example, by a mobile application running on the consumer’s user device.

At block 210, the service identifies the origin identifier of the incoming communication. For example, if the incoming communication is in the form of a telephone call, the service can determine the phone number of the caller. As a further example, if the incoming communication is in the form of an email message, messaging application message, or social media message, the service can evaluate header information or other metadata associated with the communication to determine the sender (e.g., the sender’s email address or social media handle).

At decision block 215, the service determines whether the incoming communication is from a debt collector. The service can determine whether the incoming communication is from a debt collector based on the origin identifier of the communication, and information in a debt collector data set maintained by the service that characterizes known and suspected debt collectors (e.g., maintained in the data storage area 115 of FIG. 1). For example, the service can evaluate the debt collector data set and determine whether it includes any debt collector profiles associated with the origin identifier of the incoming communication (e.g., whether any debt collectors characterized by the debt collector data set have the phone number, email address, social media handle, etc. from which the incoming communication originates). In some embodiments, the service determines that the incoming communication is from a debt collector if the debt collector data set includes a debt collector profile with a phone number, email address, social media handle, etc., that matches the origin identifier of the incoming communication. In some embodiments the debt collector data set includes confidence scores characterizing the likelihood that the corresponding entry (associated with a known or suspected debt collector) is a debt collector, and the determination is further based on whether the confidence score exceeds a threshold. For example, the service may use a threshold of 75%, and identify an incoming communication as from a debt collector when the confidence score in the debt collector data set corresponding to the associated origin exceeds 75%. In some embodiments, the threshold can be set, adjusted, and/or tuned by an administrator of the service. In some embodiments, as described herein, the service updates the confidence scores corresponding to entries in the debt collector data set based on feedback and/or other updates from users of the service, including consumers.

If at the decision block 215 the service determines that the incoming communication is not from a debt collector, then the process ends. If at the decision block 215 the service determines that the incoming communication is from a debt collector, then the process continues to perform one or more notification and monitoring steps. For example, the service can perform notification steps 220, preference monitoring steps 225, and/or regulatory compliance monitoring steps 230 (beginning with block 240, block 235, and block 260, respectively). Although FIG. 2 illustrates notification steps 220, preference monitoring steps 225, and regulatory compliance monitoring steps 230 being performed in parallel to one another, in some embodiments of the service the steps are performed one after the other. In some embodiments, one or more of the notification steps 220, preference monitoring steps 225, and regulatory compliance monitoring steps 230 are not performed.

If at the decision block 215 the service determines that the incoming communication is from a debt collector, then at block 235 the service selects a consumer profile corresponding to the consumer. The selected consumer profile can be one of many consumer profiles maintained in a consumer profile data set (e.g., maintained in the data storage area 115 of FIG. 1). The service can select the consumer profile based on information identifying the consumer (e.g., the telephone number associated with the consumer’s user device, an email address associated with the consumer, etc.). The consumer profile can include information characterizing the consumer, including the consumer’s communication preferences, the identification of the consumer’s employer, and the consumer’s location. Communication preferences can include, for example, the days and times the consumer would prefer to be contacted by debt collectors, communication channels over which the consumer would prefer to be contacted by debt collectors (e.g., telephone, emails, messaging applications, social media), the preferred telephone number and/or email address for contacting the consumer, whether a debt collector can contact the consumer’s employer, etc. It will be appreciated that the communication preferences can also include prohibitions of the same (e.g., days and times the consumer does not want to be contacted). As described above, the process then continues to one or more of block 240, block 245, and/or block 260.

At block 240, the service notifies the consumer that the incoming communication is from a debt collector. In some embodiments, the service generates a pop-up or other indicator on the consumer’s user device with notification information. Notification information can include, for example, an indication that the incoming communication is from a debt collector. As a further example, notification information can include information identifying the debt collector, including the name of the debt collector, a website associated with the debt collector, telephone and/or email contact information associated with the debt collector, etc. Identifying information associated with the debt collector can be part of, for example, the debt collector data set. In some embodiments, the notification can be based on the consumer profile associated with the consumer. For example, the consumer profile can include preference data such as how the consumer wishes to be notified the communication is from a debt collector, and what types of identifying information of the debt collector they wish to be provided to them. The process then ends.

At block 245, the service selects an employer profile corresponding to the consumer’s employer. The selected employer profile can be one of many employer profiles maintained in an employer profile data set (e.g., maintained in the data storage area 115 of FIG. 1). The service can select the employer profile based on information indicating the consumer’s employer (e.g., in the corresponding consumer profile). The employer profile can include communication preferences of the employer, including whether the employer is willing to be contacted by debt collectors and/or whether the employer will allow debt collectors to contact the employer’s employees at their place of employment (e.g., using a work telephone number or work email address to contact an employee).

At decision block 250, the service determines whether the incoming communication violates any communication preferences. As described herein, the service can monitor the incoming communication and evaluate whether it violates any consumer communication preferences and/or employer communication preferences. For example, the service can evaluate whether the incoming communication is during a day and/or time that the consumer indicated is inconvenient for them. As a further example, the service can evaluate whether the incoming communication is to a work telephone number and/or work email address associated with the consumer, when the employer does not allow such communication. If the service determines that the incoming communication violates communication preferences, the process continues to block 255. If the service determines that the incoming communication does not violate communication preferences, then the process ends.

At block 260, the service selects regulatory rules that apply to the consumer. The selected regulatory rules can be one or more of many such rules maintained in a regulatory rule data set (e.g., maintained in data storage area 115 of FIG. 1). The service can select the regulatory rules based on the geographic scope of the rules in the regulatory rule data set (e.g., over which countries, states, cities, etc. does each rule apply, as reflected in the regulatory rule data set) and the consumer’s location. The consumer’s location can be determined based on the consumer’s user device (e.g., using GPS or cellular-based location determination techniques) and/or location information in the associated consumer profile. The selected regulatory rules can be associated with a type of conduct related to consumer communication or other regulated action, and can include a rule condition (e.g., what is the required or prohibited conduct), a rule geography (e.g., what is the geographic scope of the applicability of the rule, such as federal, a state, and/or a city), and a rule action (e.g., what remedies are available to a consumer if the rule is violated and/or what steps can be taken by the service if the rule is violated).

At decision block 265, the service determines whether the incoming communication violates a regulatory rule that applies to the consumer. As described herein, the service can monitor the incoming communication and evaluate whether it violates any of the selected regulatory rules. For example, the incoming communication may occur outside of a window of time permitted by applicable laws (e.g., between 8:00am and 9:00pm local time). As a further example, the debt collector may fail to identify themselves. As a still further example, the debt collector may threaten the consumer. To detect violations, the service may utilize voice recognition and/or text recognition, depending on the type of incoming communication. If the service determines that the incoming communication violates a regulatory rule that applies to the consumer, the process continues to block 255. If the service determines that the incoming communication does not violate an applicable regulatory rule, then the process ends.

As described above, if at decision block 250 or at decision block 265 the service detects a violation (of communication preferences or an applicable regulatory rule, respectively), then the process continues to block 255. At block 255, the service performs one or more actions in response to the detection violation. For example, the service can generate a notification (e.g., a pop-up or other indicator on the consumer’s user device) informing the consumer of the violation. As a further example, the service can generate a draft message (such as email, or letter to be printed) reporting the debt collector, regulatory agencies, and/or other interested parties of the debt collector’s violation. The consumer notification and/or reporting message can include a citation to the particular rule or regulation violated by the debt consumer. In some embodiments, the actions to be performed are based on rule actions (from a regulatory rule data set) corresponding to the violated rules. In some embodiments, the actions to be performed depend on whether the violation was of a rule or regulation, or of a communication preference. The process then ends.

In some embodiments, the process 200 can notify users other than or in addition to the consumer of incoming calls from debt collectors and/or violations. For example, the service can notify interested parties or other users of the service when a violation has occurred.

In some embodiments, one or more aspects of the process 200 can be performed in real time while the incoming communication is ongoing. For example, the service can detect an incoming communication when received by the consumer’s device, can perform voice recognition as the communication is ongoing, can evaluate the voice recognition data for evidence of violations, etc. In some embodiments, one or more aspects of the process 200 can be performed after the incoming communication has ended. For example, the consumer’s user device can send information about the communication, after it has ended, to a server associated with the service for offline processing.

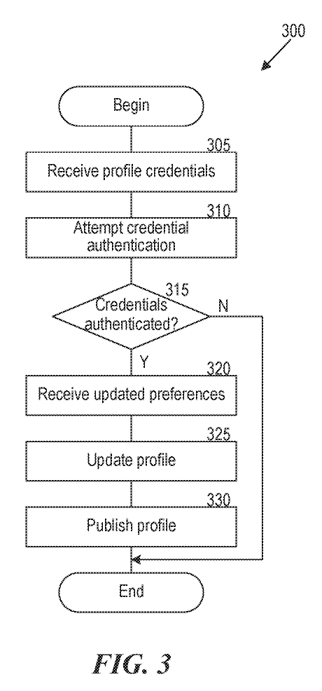

FIG. 3 is a flow diagram illustrating an exemplary process 300, executed by the consumer-protecting debt collection communication service, for updating preferences concerning debt collector communications. The process 300 can be performed by any embodiment of the consumer-protecting debt collection communication service and associated devices described herein. For example, the process can be performed entirely by the user devices 105a-e of FIG. 1, entirely by the server computers 110 of FIG. 1, or by a combination of the user devices 105a-e and the server computers 110.

The process 300 begins at block 305, with the service receiving profile credentials from a user of the service. The user can be a consumer, employer, or other interested party, with an existing profile with the service (e.g., created during a profile generation process). The credentials can include a username, password, and/or other information used to uniquely identify and verify the user.

At block 310, the service attempts to authenticate the received profile credentials. For example, the system can compare the received profile credentials with information in existing profiles maintained by the service to detect if there is a match. In some embodiments the service identifies a profile (from the maintained profiles) corresponding to the received username, and compares a password associated with the identified profile and the received password. If the credential information matches information in a maintained profile, the credentials are authenticated.

At decision block 315, the service determines whether the received profile credentials are authenticated. If the profile credentials are not authenticated, the process ends. If the profile credentials are authenticated, the process continues to block 320.

At block 320, the service receives updated communication preferences from the user of the service (e.g., the consumer, employer, or other interested party). As described herein, the updated communications preferences can characterize how the user would prefer and/or prefer not to be contacted by debt collectors. For example, a user who is a consumer may indicate the times that are inconvenient for them to be called (e.g., if they work night shifts and sleep during the day). As a further example, a user who is a consumer may indicate over what communication channels they prefer or prefer not to be contacted on (e.g., would prefer to be contacted through their email address and/or would prefer not to be contacted through a telephone number associated with their mobile device). As a further example, a user who is a consumer may specify contact information (e.g., telephone numbers and/or email addresses) associated with their work. As a still further example, a user who is a consumer may identify their employer. As a still further example, a user who is an employer may indicate whether they are willing to be contacted by debt collectors and/or whether they permit debt collectors to contact the employer’s employees when they are at work.

At block 325, the service updates a maintained profile (e.g., the profile corresponding to the authenticated credentials) based on the updated communication preferences. As described herein, the service can use the updated communication preferences (e.g., in a maintained consumer profile and/or employer profile) to evaluate whether incoming communications are in violation of the communication.

At block 330, the service publishes aspects of the updated profile. For example, the service can publish the updated communication preferences associated with the updated profile, which can enable users of the system (e.g., debt collectors and other interested parties) to determine the communication preferences of the corresponding user. The service can publish the updated profile to a secure website, make it available via an application programming interface, etc. In some embodiments, the service can publish certain profile and/or preference information to all users or subsets of users of the service. For example, if an employer updates associated preferences to indicate the employer does not wish debt collectors to contact employees at work (e.g., using work email addresses and/or work telephone numbers), the service can publish the employer’s preferences to all debt collector users of the service. The process then ends.

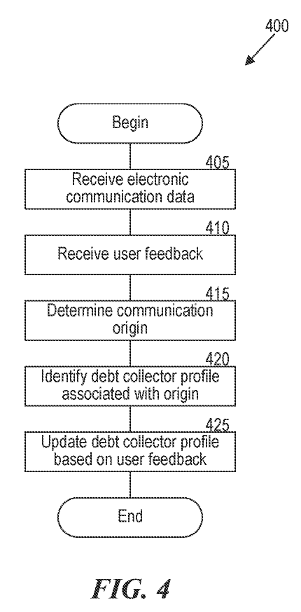

FIG. 4 is a flow diagram illustrating an exemplary process 400, executed by the consumer-protecting debt collection communication service, for updating a debt collector profile associated with a known or suspected debt collector. The process 400 can be performed by any embodiment of the consumer-protecting debt collection communication service and associated devices described herein. For example, the process can be performed entirely by the user devices 105a-e of FIG. 1, entirely by the server computers 110 of FIG. 1, or by a combination of the user devices 105a-e and the server computers 110.

The process 400 begins at block 405, with the service receiving data about an electronic communication received at a consumer’s user device. The electronic communication can be an email message, telephone call, social media message, or other. The received information can include source or origin information, header information, and/or other metadata.

At block 410, the service receives feedback information from the consumer indicating whether the communication, corresponding to the received communication data, is from a debt collector. For example, an application on the consumer’s user device can prompt the user to ask them if a communication appears to be from a debt collector, based on which the application can generate the feedback information for the service.

At block 415, the service determines the origin identifier of the electronic communication. The origin identifier can be determined, for example, using the received header information or other metadata.

At block 420, the service identifies a debt collector profile associated with the origin identifier. The debt collector profile can be one of many debt collector profiles in a debt collector data set maintained by the service that characterizes known and suspected debt collectors (e.g., maintained in the data storage area 115 of FIG. 1).

At block 425, the service updates the identified debt collector profile in the debt collector data set based on the user feedback. For example, the debt collector profile may include a confidence score characterizing the likelihood that the entity associated with the debt collector profile is a debt collector (e.g., a percentage). The service can update the confidence score based on the feedback. For example, if the received feedback indicates the origin is a debt collector, the confidence score in the corresponding debt collector profile can increase. As a further example, if the received feedback indicates the origin is not a debt collector, the confidence score in the corresponding debt collector profile can decrease. That is, for example, if the service mistakenly flags an incoming communication as being from a debt collector, when it is not, the consumer can provide feedback to the service indicating the communication was not from a debt collector, thereby training the system to not flag the communication in the future. As a further example, if the service does not flag an incoming communication that is from a debt collector, the consumer can provide feedback that the communication was from a debt collector, thereby training the system to flag the communication in the future. In some embodiments, if a consumer provides feedback indicating a communication was from a debt collector, and no debt collector profile exists that is associated with the origin of the communication, the service can generate a new debt collector profile. In some embodiments, the consumer can provide feedback identifying a debt collector for which the service has a debt collector profile, but the origin of the communication received by the consumer is not found in the debt collector profile. The service can update the debt collector profile with the new origin (e.g., new phone number, email address, etc.). The process then ends.

### Additional Embodiments

In some embodiments, consumers and other users of the service can use a website associated with the service. For example, a consumer can use a website to provide feedback that a certain phone number, email address, or other communication origin is associated with a debt collector. Based on the feedback, the service can generate a debt collector profile or update an existing debt collector profile. As a further example, a consumer can use a website to indicate they received an incoming communication from a debt collector at a work telephone number and/or work email address, and can include information such as the date and time of the communication. As a still further example, an employer can use a website associated with the service to indicate they prohibit debt collector calls of employees while at work.

In some embodiments, the service can block an incoming communication when the service detects the incoming communication is from a debt collector. For example, an application running on a consumer’s user device can reject an incoming call and/or hang up.

### CONCLUSION

The above Detailed Description of examples of the disclosed technology is not intended to be exhaustive or to limit the disclosed technology to the precise form disclosed above. While specific examples for the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

These and other changes can be made to the disclosed technology in light of the above Detailed Description. While the above description describes certain examples of the disclosed technology, and describes the best mode contemplated, no matter how detailed the above appears in text, the disclosed technology can be practiced in many ways. Details of the service and method may vary considerably in their specific implementations, while still being encompassed by the technology disclosed herein. As noted above, particular terminology used when describing certain features or aspects of the disclosed technology should not be taken to imply that the terminology is being redefined herein to be restricted to any specific characteristics, features, or aspects of the disclosed technology with which that terminology is associated. In general, the terms used in the following claims should not be construed to limit the disclosed technology to the specific examples disclosed in the specification, unless the above Detailed Description section explicitly defines such terms.

I/We claim:

1. A computer-implemented method for monitoring debt collector communications, the method comprising:
maintaining a plurality of debt collector profiles, each debt collector profile comprising an identifier;
detecting an electronic communication received at a user device, the user device associated with a consumer;
determining an origin identifier based on the electronic communication;
selecting, based on the origin identifier, a debt collector profile from the plurality of debt collector profiles, wherein the identifier associated with the debt collector profile matches the origin identifier;
determining, based on the debt collector profile, whether the electronic communication is from a debt collector;
based on the determination that the electronic communication is from a debt collector, evaluating the electronic communication for compliance with a plurality of regulatory rules;
determining whether the electronic communication violates at least one regulatory rule of the plurality of regulatory rules; and
based on the determination that the electronic communication violates at least one regulatory rule, performing an action on the user device, wherein the action is associated with the violated regulatory rule.

2. The computer-implemented method of claim 1, wherein the electronic communication is an email message addressed to an email address associated with the consumer, or a telephone call to a telephone number associated with the user device.

3. The computer-implemented method of claim 1, the method further comprising:
detecting that the electronic communication has terminated, and
wherein the evaluation of the electronic communication for compliance with the plurality of regulatory rules occurs after the electronic communication has terminated.

4. The computer-implemented method of claim 1, the method further comprising generating a notification on the user device that the electronic communication is from a debt collector.

5. The computer-implemented method of claim 1, wherein the debt collector profile comprises a confidence score, and wherein the determination that the electronic communication is from a debt collector is based on whether the confidence score exceeds a confidence threshold.

6. The computer-implemented method of claim 5, the method further comprising:
receiving feedback indicating whether the origin identifier is associated with a debt collector; and
updating the confidence score associated with the debt collector profile based on the feedback.

7. The computer-implemented method of claim 1, wherein at least one debt collector profile from the plurality of debt collector profiles comprises a plurality of identifiers associated with a debt collector.

8. The computer-implemented method of claim 7, wherein the plurality of identifiers are different telephone numbers associated with the debt collector.

9. The computer-implemented method of claim 7, wherein the plurality of identifiers are different email addresses associated with the debt collector.

10. The computer-implemented method of claim 1, wherein each of the plurality of regulatory rules comprises a condition, and wherein the evaluation of whether the electronic communication violates the regulatory rule is based on whether the condition is satisfied.

11. The computer-implemented method of claim 10, wherein the condition characterizes the time of an electronic communication, whether the electronic communication comprises threatening content, or whether the electronic communication comprises deceptive content.

12. The computer-implemented method of claim 1, the method further comprising:
receiving a profile associated with the consumer, the profile comprising a communication preference of the consumer;
determining whether the electronic communication violates the communication preference; and
wherein performing the action on the user device is based further on whether the electronic communication violates the communication preference.

13. The computer-implemented method of claim 1, wherein the performed action comprises generating a notification on the user device that the electronic communication violates a regulatory rule.

14. The computer-implemented method of claim 1, the method further comprising:
receiving a profile associated with the consumer, the profile comprising an employer identifier, and a work email address or a work telephone number;
selecting, based on the employer identifier, an employer profile from a plurality of employer profiles;
determining whether the electronic communication is received by the work email address or the work telephone number; and
based on the determination, evaluating whether the electronic communication violates a communication preference associated with the selected employer profile.

15. The computer-implemented method of claim 14, the method further comprising transmitting the employer profile communication preference to a computing system associated with the selected debt collector profile.

16. A non-transitory computer-readable medium carrying instructions that, when executed by a computing system, cause the computing system to perform operations for monitoring debt collector communications, the operations comprising:
maintaining a plurality of debt collector profiles, each debt collector profile comprising an identifier;
detecting an electronic communication received at a user device, the user device associated with a consumer;
determining an origin identifier based on the electronic communication;
selecting, based on the origin identifier, a debt collector profile from the plurality of debt collector profiles, wherein the identifier associated with the debt collector profile matches the origin identifier;
determining, based on the debt collector profile, whether the electronic communication is from a debt collector;
based on the determination that the electronic communication is from a debt collector, evaluating the electronic communication for compliance with a plurality of regulatory rules;
determining whether the electronic communication violates at least one regulatory rule of the plurality of regulatory rules; and
based on the determination that the electronic communication violates at least one regulatory rule, performing an action on the user device, wherein the action is associated with the violated regulatory rule.

17. The non-transitory computer-readable medium of claim 16, wherein the debt collector profile comprises a confidence score, and wherein the determination that the electronic communication is from a debt collector is based on whether the confidence score exceeds a confidence threshold.

18. The non-transitory computer-readable medium of claim 17, the operations further comprising:
receiving feedback indicating whether the origin identifier is associated with a debt collector; and
updating the confidence score associated with the debt collector profile based on the feedback.

19. The non-transitory computer-readable medium of claim 16, the operations further comprising:
receiving a profile associated with the consumer, the profile comprising an employer identifier, and a work email address or a work telephone number;
selecting, based on the employer identifier, an employer profile from a plurality of employer profiles;
determining whether the electronic communication is received by the work email address or the work telephone number; and
based on the determination, evaluating whether the electronic communication violates a communication preference associated with the selected employer profile.

20. The non-transitory computer-readable medium of claim 19, the operations further comprising transmitting the employer profile communication preference to a computing system associated with the selected debt collector profile.
